(19) United States
(12) Patent Application Publication
(10) Pub. No.: US 2005/0042758 A1
(43) Pub. Date: Feb. 24, 2005

(54) Leak detection method using microencapsulated dye precursor

(75) Inventors: Gary J. Zyhowski, Lancaster, NY (US); Rajiv R. Singh, Getzville, NY (US); Raymond H. Thomas, Pendleton, NY (US)

Correspondence Address: Colleen D. Szuch, Esq.;Honeywell Corporation, Law Department, AB, P.O. Box 2245, Morristown, NJ, 07962-2245, US

(73) Assignee: Honeywell Corporation

(21) Appl. No.: 10/644,569

(22) Filed: Aug. 20, 2003

(51) Int. Cl. G01N 31/00

(52) U.S. Cl. 436/3

(57) ABSTRACT

A method of detecting a leakage of a chemical from a closed system into the environment and/or revealing the location of the leakage is provided. The method includes the steps of: placing a test strip in close proximity of or in direct contact with a suspected leak in the closed system, the test strip including a support material and a color forming composition disposed on the support material, the color forming composition including a dye precursor encapsulated in a microcapsule, a developer and optionally a filler; and detecting development of a color on the test strip in response to contact of the microcapsule with the chemical thereby indicating the presence of and/or the revealing the location of the leak.

### BACKGROUND OF THE INVENTION

1. Field of the Invention

The present invention generally relates to a method of detecting a leakage from a closed system into the environment and/or revealing the location of the leakage. More particularly, the present invention relates to a method of detecting a leak in a closed system and/or revealing the location of the leak.

2. Description of the Prior Art

Leak detection of volatile compounds including liquids and compressed gases is practiced for reasons, such as health and safety, preservation of the environment, system maintenance, and conservation of the compound itself.

Conventional methods of leak detection in the field include the use of hand-held and bench model electronic leak detectors. These devices require periodic calibration, maintenance, and a power supply. They may be difficult to carry or position for leak detection, especially if many potential leak sites need inspection.

Electronic leak detection devices may give a false positive signal if an interfering compound is detected in the same area. If the leak is small enough to be below the lower limit of detection for the instrument, the leak will go undetected. Moreover, a person has to stay in contact with the leak detection device to interpret the instrument response.

Ultrasonic leak detectors may not have a problem with false positive signals from the presence of other compounds, but they can be confounded by other sounds entering and influencing the same sound field the unit is in. Commercial leak detection soap solutions are typically used for detection of larger leaks. Therefore, a leak detection medium that can detect small leaks and relate the leak to a definitive location would be useful. It would also be useful to have a detection device that did not require constant monitoring by a person. A leak detection device that did not require calibration in the classical sense or a power supply would likewise be advantageous.

Small leaks of volatile compounds from closed mechanical systems, storage containers, or transfer/distribution piping are often hard to pin-point because there are several potential leak sites, such as piping joints, in close proximity to one another. Air currents can hasten mixing of the compound in air, making it too diffuse to pinpoint. Similarly, air currents can displace the leaking material so that the leak appears to be in a different location than actual. For this reason, electronic leak detectors, i.e., “sniffers,” often cannot pinpoint where a slow leak is emanating from.

It is also possible that the sensitivity of the electronic device is not high enough to detect small leaks. Commercial leak detection bubble solutions often are not adequate for detection of small leaks. Leaks such as this occur, for example, in refrigerating systems, solvent vapor degreasing systems, and industrial processes carrying volatile organic compounds. Similarly, leaks occur in natural gas distribution and delivery piping and in the combustion equipment they supply.

Leak detection at the level offered by the present invention can facilitate detection and control of emissions that may harm the environment or because the leaking compound possesses a property, such as flammability which would pose a threat to persons and property if ignition were to occur.

Closed systems, such as those used for refrigeration and air-conditioning may be critical, for example, to chemical process operations, employee safety, food and biologicals preservation, and data systems reliability. In such cases, early detection of leaks can prevent system downtime if means for detecting volatile organic compound (VOC) leaks, including slow leaks of such compounds, were available.

Accordingly, the present invention provides a method of detecting leaks of volatile organic compounds, slow leaks and leaks that are in the field which are often not detectable with other methods or equipment. The benefits of the present leak detection method will become evident from the detailed description of the invention that follows. In particular, the present invention uses a novel pressure-sensitive or thermally-sensitive printing paper as a leak detection media or the use of a microencapsulated leak detection media for detecting hydrofluorocarbons or hydrochlorofluorocarbons leaks.

### SUMMARY OF THE INVENTION

The present invention provides a method of detecting a leakage of a chemical from a closed system into the environment and/or revealing the location of the leakage. The method includes the steps of:
placing a test strip in close proximity of or in direct contact with a suspected leak in the closed system, the test strip including a support material and a color forming composition disposed on the support material, the color forming composition including a dye precursor encapsulated in a microcapsule, a developer and optionally a filler; and
detecting development of a color on the test strip in response to contact of the microcapsule with the chemical thereby indicating the presence of and/or the revealing the location of the leak.

Leak detection at the level offered by the present invention can facilitate detection and control of emissions that may harm the environment or because the leaking compound possesses a property such as flammability which would pose a threat to persons and property if ignition were to occur.

Further, closed systems such as those used for refrigeration and air-conditioning may be critical, for example, to chemical process operations, employee safety, food and biological preservation, and data systems reliability. In such cases, early detection of leaks can prevent system downtime.

These and other benefits of this leak detection method will become evident from the detailed description of the invention that follows.

### DETAILED DESCRIPTION OF THE INVENTION

The present invention provides a leak detection tape, paper, patch or film that can be placed at or on a suspected leak site, or multiple sites. When exposure of compound to the leak detection medium is sufficient, a color will develop on the leak detection medium, indicating that there is a leak.

The basis for the operation of the leak detection test strip described herein, which can be a tape, paper, patches or film, is the concept that when a dye precursor contained in a microcapsule is exposed to a volatile organic compound, a color develops.

The test strip according to the present invention includes: a support material; a color forming composition including an encapsulated dye precursor coated on a surface of the substrate; a developer; and optionally, a filler.

Support Material

The support material is preferably a flexible substrate, such as a thin sheet of paper, plastic, metal or a combination thereof. However, other materials or combination of materials that are commonly known to those skilled in the art can also be used.

Suitable substrates include any sheet material conventionally used to prepare test strips, including, but not limited to, paper; paper coated on one or both sides with an alpha-olefin polymer such as polyethylene; acetate films such as polyvinyl acetate and cellulose acetate film; polyvinyl acetal film; polystyrene film; polypropylene film; polyester film such as polyethylene terephthalate film; polyamide film; polyimide film; nitrocellulose film; polycarbonate film; polyvinylchloride film; composite films such as polyester, polypropylene or polystyrene film coated with polyethylene film; metallized paper or films; metal/paper laminates and Perlon gauze.

Color Forming Composition

The color forming composition includes a dye precursor encapsulated in a microcapsule, a developer and optionally, a filler.

A dye precursor, such as, leuco or carbinol intermediate and a developer, such as, an acid developer, can be used in the present invention to prepare the detection media, such as the test strip, of the present invention.

Dye Precursor

The encapsulated dye precursor can be a leuco dye, a carbinol based dye, a diazonium salt capable of coupling with a coupling agent or a combination thereof.

Leuco Dye Precursor

The leuco dye can be one of the following type of dyes:
(1) a leuco base of a triarylmethane dye, such as crystal violet, Cl Basic Violet 1, Cl Basic Violet 2, Cl Basic Blue, Cl Victoria Blue, crystal violet lactone, N-benzoyl leuco-methylene blue or a combination thereof;
(2) phthalide leuco dyes, bisindophtalides, carbazolyl methanes, fluorans or a combination thereof; or
(3) a carbinol based dye, such as, malachite green, Cl Acid Blue 9, Cl Food Blue 2 or a combination thereof.

In the case of leuco dyes, an acidic material, such as salicylic acid, phenolic compound, millorganite clay or attapulgite clay can serve as the developer.

Non-limiting examples of the dyes that can be used as dye precursors in this invention include, but are not limited to, Leuco bases of derivative triarylmethane dyes, such as, crystal violet, Cl Basic Violet 1, Cl Basic Violet 2, Cl Basic Blue, Cl Victoria Blue, crystal violet lactone, N-benzoyl leuco-methylene blue, and carbinol bases of dyes, such as, malachite green, Cl Acid Blue 9, Cl Food Blue 2 and phthalide leuco dyes.

Leuco Dye Developer

Illustrative examples of the acidic compounds that can be used as developers in the present invention are listed in Table 1 below. These examples are illustrative and should not be construed as being limiting.

TABLE 1
Examples of Acidic Developers for Leuco Dye Precursors

Propionic CH3CH2COOH
Butyric CH3(CH2)2COOH
Valeric CH3(CH2)3COOH
Caproic CH3(CH2)4COOH
Caprylic CH3(CH2)6COOH
Capric CH3(CH2)8COOH
Lauric CH3(CH2)10COOH
Myristic CH3(CH2)12COOH
Palmitic CH3(CH2)14COOH
Stearic CH3(CH2)16COOH
Oleic Cis-9-Octadecenoic
cis,cis-9, 12-″″ Linoleic
cis,cis,cis-9, 12, 15″″ Linolenic
Cyclohexanoic cyclo-C6H11COOH
Phenylacetic C6H5CH2COOH
Benzoic C6H5COOH
o-Toluic o-CH3C6H5COOH
m-Toluic m-CH3C6H5COOH
p-Toluic p-CH3C6H5COOH
o-Chlorobenzoic o-ClC6H5COOH
m-Chlorobenzoic m-ClC6H5COOH
p-Chlorobenzoic p-ClC6H5COOH
o-Bromobenzoic o-BrC6H5COOH
m-Bromobenzoic m-BrC6H5COOH
p-Bromobenzoic p-BrC6H5COOH
o-Nitrobenzoic o-NO2C6H5COOH
m-Nitrobenzoic m-NO2C6H5COOH
p-Nitrobenzoic p-NO2C6H5COOH
Phthalic o-C6H5(COOH)2
Isophthalic m-C6H5(COOH)2
Terephthalic p-C6H5(COOH)2
Salicylic o-HOC6H5COOH
p-Hydroxybenzoic p-HOC6H5COOH
m-Aminobenzoic m-NH2C6H5COOH
p-Aminobenzoic p-NH2C6H5COOH

Suitable Leuco dyes that yield a colored compound upon reaction with an acid include leuco crystal violet, leuco malachite green, crystal violet lactone, benzoyl leuco methylene blue and the acid-sensitive leuco dye compounds belonging to the class of the bisindophtalides and carbazolyl methanes described are described in U.S. Pat. Nos. 5,084,433 and 5,206,118, the contents of which are incorporated herein by reference as if fully set forth herein.

Particularly suited for use according to the present invention are leuco dyes belonging to the class of the fluorans as described, e.g., in published European patent application 0 155796, German published patent applications (DE-OS) 35 34 594 and 43 29 133, and U.S. Pat. Nos. 3,957,288 and 4,011,352, all of which are incorporated herein in their entirety.

Japanese Patent Application No. 123086/82 and U.S. Pat. Nos. 4,751,165, 4,842,976, and 6,562,542 describe basic leuco dye based systems that can be used in the image-forming material for instant coloring by contact with an acid and are all incorporated herein in their entirety.

In one embodiment, the acid-sensitive leuco dyes can be encapsulated to form microcapsules containing solutions of the leuco dye compounds and thereafter the microcapsules are coated onto the surface of a paper sheet. The integrity of the microcapsules are altered by contact with leaking gas or liquid to be detected, thereby releasing the leuco dye, which becomes colored upon contacting an acidic developer, such as an acidic clay, also present on the surface of the paper sheet. Alternately, the microcapsules can be placed on the back side of one paper sheet and the developer on the front side of an underlying sheet.

In another embodiment, the present invention employs one substrate having all of the color-forming components contained within the microcapsules. The dye precursor and acidic developer can be placed within the rupturable microcapsules to produce a self-contained test strip according to the present invention.

In this approach, microcapsules that contain all of the mark forming components are present in the same solution. The leuco dye color-former reacts with an acidic developer, such as a phenol. The solvent mixture contains a polar solvent that favors the uncolored form of the leuco dye. Upon imaging, evaporation of the polar component of the solvent mix results in a non-polar environment, favoring the colored form of the dye.

Diazonium Salt Dye Precursor

The encapsulated dye precursor can also be a diazonium salt capable of coupling with a coupling agent.

The diazonium salts can be any diazonium salt known in the art. Preferably, such diazonium salts are aromatic and more preferably, are derivatives of diphenylamine-4-diazonium salts, including, for example, 4-diazodiphenylamine sulfate. Examples of such aromatic diazonium salts include: diphenyl-4-diazonium sulfate; 2-4-(N-(naphthyl-2-methyl)-N-propylamino)-benzenediazonium sulfate; chloro-diphenyl-4-diazonium sulfate; 4-(3-phenylpropylamino)-benzenediazonium sulfate; 4-(N-ethyl-N-(benzyl)-amino)-benzenediazonium sulfate; 4-(N,N-dmethylamino)-benzenediazonium tetrafluoroborate; 4-(N-(3-phenyl-mercapto-propyl)-N-ethyl-amino)-2-chlorobenzenediazonium sulfate; 4-(4-methylphenoxy)-benzenediazonium sulfate; 4-(phenylmercapto)-benzenediazonium sulfate; 4-phenoxybenzenediazonium sulfate; 4-(benzoylamino)-benzenediazonium hexafluorophosphate; methylcarbazole-3-diazonium sulfate; 3-methyl-diphenyleneoxide-2-diazonium sulfate, 3-methyl-diphenylamine-4-diazonium sulfate, 2,3′,5-trimethoxydiphenyl-4-diazonium sulfate; 2,4′,5-triethoxydiphenyl-4-diazonium sulfate; 4-(3-(3-methoxyphenyl)-propylamino)-benzenediazonium sulfate; 4-(N-ethyl-N-(4-methoxybenzyl)-amino)-benzenediazonium sulfate; 4-(N-(naphthyl-(2)-methyl)-N-n-propylamino)methoxybenzenediazonium sulfate; 4-(N-(3-phenoxypropyl)-N-methylamino)-2,5-dimethoxybenzenediazonium tetrafluoroborate; 4-(N-(3-phenylmercaptopropyl)-N-ethylamino)-2-chloro-5-methoxybenzenediazonium sulfate; 4-(4-(3-methylphenoxy)-phenoxy)-2,5-dimethoxybenzenediazonium sulfate; 4-(4-methoxy-phenylmercapto)-2,5-diethoxybenzenediazonium sulfate; 2,5-diethoxy-4-phenoxybenzene-diazonium sulfate; 4-(3,5-dimethoxybenzoylamino)-2,5-diethoxybenzene-diazonium hexafluorophosphate; methoxycarbazole-3-diazonium sulfate; 3-methoxy-diphenyleneoxide-2-diazonium sulfate and methoxydiphenyl-amine-4-diazonium sulfate.

Diazonium salts derived from the following amines are also suitable for use in the present invention: 4-amino-3-methoxydiphenylamine, 4-amino-2-methoxydiphenylamine, 4′-amino-2-methoxydiphenylamine, 4′-amino4-methoxydiphenylamine, 4-amino-3-ethoxydiphenylamine, 4-amino-3-hexyloxydiphenylamine, 4-amino-3-beta-hydroxyethoxy-diphenylamine, 4′-amino-2-methoxy-5-methyldiphenylamine, 4-amino-3-methoxy-6-methyldiphenylamine, 4′-amino-4-n-butoxydiphenylamine, 4′-amino-3′,4-dimethoxydiphenylamine, 4-amino-diphenylamine, 4-amino-3-methyl-diphenylamine, 4-amino-3-ethyldiphenylamine, 4′-amino-3-methyl-diphenylamine, 4′-amino-4-methyl-diphenylamine, 4′-amino-3,3′-dimethyldiphenylamine, 3′-chloro-4-amino-diphenylamine, 4-amino-diphenylamine-2-sulfonic acid, 4-aminodiphenylamine-2-carboxylic acid, 4-aminodiphenylamine-2′-carboxylic acid and 4′-bromo-4-aminodiphenyl-amine. Preferred are 4-amino-diphenylamine, 3-methyl-4-aminodiphenyl-amine, 3-alkoxy-4-aminodiphenylamines having 1 to 3 carbon atoms in the alkoxy group and 3-methoxy-4-aminodiphenylamine.

The counter anion of the aromatic diazonium salt can be a halide, such as chloride, bromide or fluoride; sulfate; hydrogen sulfate; phosphate; hydrogen phosphate; dihydrogen phosphate; sulfonate, such as, methane sulfonate, trifluoromethane sulfonate, toluene sulfonate, naphthalene sulfonate and mesitylene sulfonate; hexafluorophosphate and tetrafluoroborate.

Examples of the particularly preferred monomeric aromatic diazonium salts include 2-methoxy-4-phenylaminobenzenediazonium-hexafluorophosphate (diazo MSPF6) represented by the formula: 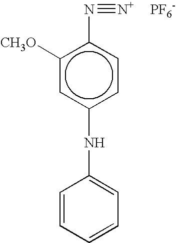
2-methoxy-4-phenylaminobenzenediazonium p-toluenesulfonate represented by the formula: 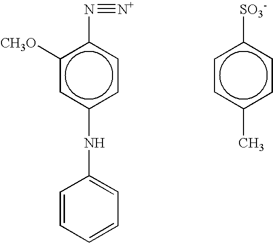
and a combination thereof.

Examples of the particularly preferred oligomeric aromatic diazonium salts include compounds represented by the formula: 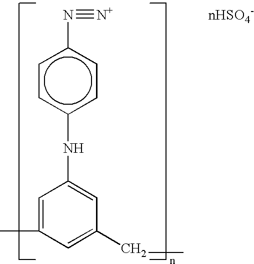
which is manufactured by St. Jean Photochemicals, Quebec, Canada, under the name DTS-18; 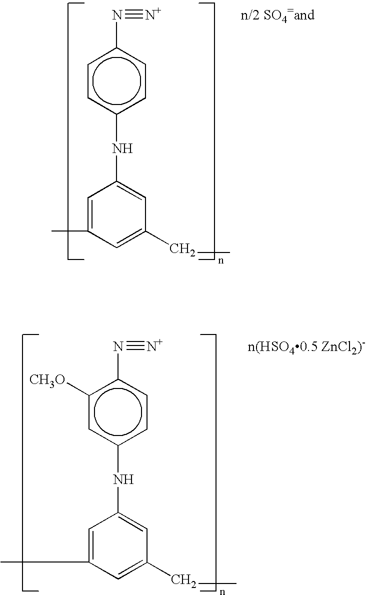
wherein n is from 1 to 11; and a combination thereof. Mixtures of any of the aforementioned diazonium salts are also suitable.
Diazonium Salt Developer

A dye precursor, such as, a diazonium salt, in combination with a developer system for the diazonium salt, such as, a coupler and a base or an acid, as the case may be, can be used in the present invention to prepare the detection media, such as the test strip, of the present invention.

Developer systems for diazonium salts that are employed in recording materials to produce colored images from colorless or substantially colorless electron donating materials are described in U.S. Pat. Nos. 4,842,979; 6, 348,432; 6, 432,876; 6,403,528; 2,712,507; 2,730,456; 2,730,457; 3,418,250; 3,432,327; 3,981,821; 3,993,831; 3,996,156; 3,996,405; 4,000,087 and 6,340,550. Specific examples of such recording materials include pressure sensitive carbonless copying paper, heat-sensitive recording paper, electrothermographic recording paper, Cycolor™ photographic materials and the like. These references include a developer sheet (also referred to as a CF coated front sheet) including a substrate coated with an electron acceptor which reacts with a leuco dye transferred to the surface of the developer sheet to form an image thereon.

Coupling Agent

A coupling agent is necessary to couple with the diazonium salts for development of color.

Suitable coupling agents include, but are not limited to, aromatic amines, aromatic hydroxy compounds such as phenol and naphthols, heterocyclic compounds, such as pyrrole, pyridine, pyrimidine, indole and similar ring structures. Compounds with enolizable aliphatic ketone segments (e.g., active methylene groups) of the structure X-CH2—C (double-bonded oxygen)-Y where X is —COOH, —CN, —COR and R can be alkyl or aryl and Y is an amino group (unsubstituted or substituted). Examples of enois would be acetoacetanilide and 3-methyl-1 -phenyl-5-pyrazolone. Further examples of coupling agents include but are not limited to 2,4-dihyroxyquinoline, N,N-dimethylaniline, 3-hydroxy-2-naphthanilide, naphthylamine, 8-amino-1-naphthol-3,6-disulfonic acid, 7-amino-1-naphthol-3-sulfonic acid, (benzolyacetic acid-2′-[2-(2-hydroxy-3-naphthoylamino)phenylthio]anilide; 1,2-bis (benzylacetamido)benzene; 4-toluenesulfonyloxy)anilide.

The coupling agent and a basic component (i.e., a source of hydroxide or an alkaline salt such as sodium acetate or sodium carbonate) are applied to the substrate external to the microcapsule. Through varied routes of chemical synthesis (e.g., diazotization), nearly all aromatic primary amines can form diazo compounds. Commonly used aromatic primary amines that can be subjected to diazotization include 5-amino-1,2,4-thiadiazole, 2-amino-6-nitrobenzothiazole, 2-amino-3,5-dinitro-thiophene, 1-amino-2-naphthol-4-sulfonic acid, 2-amino-4-sulfonnic acid and 1-naphthalene-suflamic acid. Examples of the basic component include, but are not limited to, ammonium salts, amines, amides, urea and thiourea or their derivatives, thiazoles, pyrroles, pyrimidines, piperazines, guanidines, indoles, imidazoles, imidazolines, triazoles, morpholines, piperidines, amidines, formamidines and pyridines. Specific examples of the nitrogen-containing compounds are ammonium acetate, tricyclohexyl-amine, tribenzylamine, octadecylbenzylamine, stearylamine, allylurea, thiourea, methylthiourea, allylthiourea, ethylenethiourea, 2-benzyl-imidazole, 4-phenylimidazole, 2-phenyl-4-methylimidazole, 2-undecyl-imidazoline, 2,4,5-trifuryl-2-imidazoline, 1,2-diphenyl-4,4-dimethyl-2-imidazoline, 2-phenyl-2-imidazoline, 1,2,3-triphenylguanidine, 1,2-ditolylguanidine, 1,2-dicyclohexylguanidine, 1,2,3-tricyclohexylguanidine, guanidine trichloroacetate, N,N′-dibenzylpiperazine, 4,4′-dithiomorpholine, morpholinium trichloroacetate, 2-aminobenzothiazole and 2-benzoyl-hydrazinobenzothiazole. Additional compounds are described in U.S. Pat. No. 4,842,979, which is incorporated herein in its entirety by reference.

Preferably, coupling is carried out in the presence of a basic component, such as, ammonium salts, amine compounds, amides, ureas, thioureas, thiazoles, pyrroles, pyrimidines, piperazines, guanidines, indoles, imidazoles, imidazolines, triazoles, morpholines, piperidines, amidines, formamidines, pyridines and a combination thereof.

Solvents for Dye Precursor

The dye precursor is preferably solubilized in a solvent and then housed in a microcapsule provided it is not affected by the dye/solvent combination contained within.

Alternatively, the dye precursor may be dispersed in a carrier fluid or fluids that may or may not be a suspension or emulsion. Materials having capacity to dissolve or carry a dye precursor, as in a dispersion, emulsion, or suspension, include alcohols, ketones, aldehydes, esters, branched-acid polyol esters, mixed-acid polyol esters, polyalkylene glycols, alkyl benzenes, benzylated ethylbenzene, benzyl butyl phthalate, isopropylbiphenyl and diisopropyinaphthalene. Such fluids typically are selected to have a high-boiling point or exhibit a minimal vapor pressure for the temperature range of the application.

Further non-limiting examples of solvent/carrier fluids that can be used to dissolve, suspend or otherwise carry a dye precursor are listed in Table 2.

TABLE 2
Solvents and Carriers for the Dye Precursors

Linear, branched, cyclic, saturated or unsaturated alcohols
Benzyl alcohol
Glycerol
Ethylene glycol
Propylene glycol
Phenol
o-, m-, p-cresol
o-, m-, p-chlorophenol
o-, m-, p-nitrophenol
catechol
cinnamyl alcohol
phenyl ethyl alcohol
1,3-propane diol
pentaerythritol
aldehydes and ketones
benzaldehyde
m-mitrobenzaldehyde
o-tolualdehyde
acetophenone
benzophenone
oils
paraffin
silicone
polyvinylether
polyol ester
polyalkylene glycol
mineral oil
alkybenzenes
perfluoropolyether
chlorotrifluoroethylene
hydrofluoropolyether
Amides
butanamide CH₃(CH₂)₂CONH₂
N-methylpropanamide CH₃CH₂CONHCH₃
Glycols, Glycol ethers
Dipropylene glycol
Diethylene glycol
Butyl diglycol
Butyl triglycol
Ethyl diglycol
Hexyl diglycol
Propyl glycol
Diethylene glycol monobutyl ether
Ethylene glycol monobutyl ether
Ethylene glycol monoethyl ether
Diethylene glycol monomethyl ether
Tripropylene glycol n-butyl ether
Hydroquinone monobutyl ether
Diethylene glycol monoethyl ether
Triethylene glycol monoethyl ether
Diethylene glycol monohexyl ether
Ethylene glycol monopropyl ether
Ethylene glycol phenyl ether
Phthalates, Adipates
dibutyl phthalate
Diethyl phthalate
Diisobutyl phthalate
Diisononyl phthalate
Diisodecyl phthalate
Dioctyl phthalate
Dilauryl phthalate
Dioctyl adipate

Other solvents and carriers for the dye precursors include n-butyl propionate, tert-butyl hydroquinone, phosphoric esters, phthalic esters and other carboxylic acid esters, fatty acid amides, alkylated biphenyls, alkylated terphenyls, chlorinated paraffins, alkylated naphthalenes, diarylethanes, and the like. Specific examples of these organic solvents include tricresyl phosphate, trioctyl phosphate, octyldiphenyl phosphate, tricyclohexyl phosphate, dibutyl phthalate, dioctyl phthalate, dilauryl phthalate, dicyclohexyl phthalate, butyl oleate, diethylene glycol dibenzoate, dioctyl sebacate, dibutyl sebacate, dioctyl adipate, trioctyl trimellitate, acetyltriethyl citrate, octyl maleate, dibutyl maleate, isopropylbiphenyl, isoamylbiphenyl, chlorinated paraffins, diisopropylnaphthalene, 1,1′-ditolytethane, 2,4-di-t-aminophenol and N,N— and dibutyl-2-butoxy-5-t-octylaniline. Additional compounds are described in the previously incorporated U.S. Pat. No. 4,842,979.

It is also possible to functionalize either the solvent or the dye in such a way to affect the necessary solvency between dye and solvent. A solvent with a given chemical structure having appropriate non-volatile characteristic that does not afford proper solvency for a given dye precursor can be functionalized. A specific chemical group or groups, such as hydrogen, halogen (chlorine, fluorine, bromine, iodine), hydrocarbons of straight or branched chain, unsaturated, cyclic, aromatic (methyl, ethyl, propyl, isopropyl, butyl, isobutyl, phenyl, benzyl, biphenyl, alkene, alkyne), oxygen-containing (hydroxyl, ketone, aldehyde, organic acid, ether, or ester), nitrogen-containing (nitro-, nitroso-, amine and amide), sulphur-containing (sulfo- and sulfonyl) can be appended to the original solvent via chemical reaction. In the same way, a dye precursor can be functionalized with the aforementioned groups.

Solvents are preferably chosen to be relatively non-volatile so that the microcapsules are not stressed by internal pressure as might occur with volatile solvents. Alternatively, a finely divided dye intermediate can be microencapsulated.

Preparation of Microcapsules

Processes for manufacture of microcapsules are well known in the art and detailed descriptions of methods of making microcapsules are found in the latest Kirk-Othmer Encyclopedia, Vol.16, pp. 628-649 and Remington's Pharmaceutical Sciences, Mack Publishing Co., Easton Pa. (1990). Also, U.S. Pat. No. 6,528,165 to Chandler (Mar. 4, 2003) and U.S. Pat. No. 6,586,364 to Kubota et al. (Jul. 1, 2003) describe a variety of methods for making microcapsules that are useful in preparing the microcapsules that are suitable for use in the present invention. All of which are incorporated herein in their entirety by reference.

Such microcapsules may be produced by coacervation methods, interfacial polymerization methods or in situ polymerization methods described in Japanese Laid-Open Patent Applications Nos. 58-33492 and 58-82785, which are incorporated herein in their entirety by reference.

Coacervation methods for microencapsulation using gelatins, acrylics or styrenics and crosslinkable polymers, interfacial crosslinking methods are described in U.S. Pat. No. 6,071,852 Atkinson (Jun. 6, 2000) and U.S. Pat. No. 5,585,051 Hosie et al. (Dec. 17, 1996), which are incorporated herein in their entirety by reference. In situ polymerization methods are described in U.S. Pat. Nos. 5,464,803; 4,001,140; 4,100,103; 4,105,823 and 4,396,670, which are incorporated herein in their entirety by reference. The interfacial techniques are described in U.S. Pat. Nos. 4,379,071; 4,428,983; 4,412,959; 4,402,856; 4,253,682 and 4,181,639, which are incorporated herein in their entirety by reference.

Preferably, the encapsulated dye is encapsulated by a method, such as, solvent evaporation, simple coacervation, complex coacervation, polymer-polymer incompatibility, centrifugal force, submerged nozzle process, spray drying, fluidized-bed coating, desolvation, extractive drying, interfacial polymerization, in situ polymerization, biliquid column, electrostatic encapsulation, ethylene polymerization, very low temperature casting, supercritical fluid extraction and a combination thereof.

For example, one can microencapsulate a fine dispersion of a dye precursor, such as a diazonium salt capable of coupling with a coupling agent, such as 2-hydroxy-3-napthoic acid anilide that would form an azo dye. Such microencapsulation of a fine dispersion of a dye precursor is described in U.S. Pat. No. 4,842,979, the contents of which are incorporated by reference as if fully set forth herein.

The term “soluble” as used herein is intended to include those situations where the reagent is capable of dissolving in the appropriate liquid under the conditions which are to be used for the crosslinking reaction as well as those situations where the reagent, particularly a crosslinkable polymeric material, such as gelatin, may not dissolve in the respective liquid under the conditions to be used for the crosslinking reaction, but will dissolve under different conditions, such as at a higher temperature, and then remain dissolved when the conditions are changed to those which are to be used for the crosslinking reaction.

It is within the ability of a person of ordinary skill in the art to select an effective crosslinking agent for a particular polymeric material from among the many which are known in the art to form the microcapsule.

Crosslinking agents that are soluble in one or more water-miscible organic liquids include zirconium complexes, such as zirconium potassium carbonate and zirconium ammonium carbonate; zirconium chloride; boric acid; and borates, such as sodium borate.

Crosslinking agents that are soluble in one or more liquids include acid dichlorides, such as succinyl chloride and adipoyl chloride; titanium complexes, e.g. tetraisopropoxy titanate; dicarboxylic acid anhydrides, such as phthalic anhydride; aliphatic polyisocyanates, such as 1-pentyl-2-heptyl-3,4-bis-(9-isocyanatononyl)-cyclohexane; and aromatic polyisocyanates, such as homopolymers of toluene diisocyanate.

Representative crosslinkable polymeric materials which are soluble in one or more suitable liquids are gelatin, particularly gelatin of 175 to 300 Bloom; carboxymethyl cellulose; polyvinyl alcohol; polysaccharides, such as agar and natural and modified starches; gum arabic and sodium alginate. Representative crosslinkable polymeric materials soluble in one or more suitable liquids are polymers containing multiple hydroxy, carboxy, ester and/or amino groups, including polyvinyl acetate, cationic poly(aminosilicones), cellulose acetate butyrate, styrene-allylic alcohol copolymers, ethylene-vinyl acetate copolymers and acrylic polymers, such as poly(methylmethacrylate).

Preferably, the microcapsule should be susceptible to diffusion, dissolution, or rupture when exposed to the leaking organic vapor intended to be detected so that the precursor can contact the reagents external to the microcapsule. Although it may not be advantageous in all cases, the components housed inside the microcapsule and external to the microcapsule could be switched if desired.

The microcapsule shells used to contain, for example, the dye precursor or dye intermediate, can be continuous or polynuclear.

Continuous or polynuclear microcapsules could be used to construct a layered system having dye precursor in one layer and complementary developer system in an adjoining layer. The layers could be deposited in sequence on a substrate such as paper or a polymeric substrate.

The microcapsules and developer system can also be integrated into separate adjoining polymeric layers or laminations. In such a case, the polymeric material must be chosen so that the leaking material to be detected can diffuse through the polymeric layer.

Alternatively, the dye precursor or the intermediate and the developer system can be independently microencapsulated and then deposited on a substrate or integrated into a single polymeric layer.

Polymeric films into which dye components are integrated can optionally serve as substrate. Such systems, which do not use microcapsules, are also contemplated by the present invention. The dye precursor or intermediate can be dispersed throughout a polymeric (including pre-polymer or monomer) material that is then deposited onto a substrate. The polymeric material can be a polymer dissolved in a solvent or a pre-polymer or monomer which could be polymerized after deposition as a layer using appropriate means such as light, oxygen, and heat.

The layer thus formed is washed or treated to remove or inactivate the dye precursor or intermediate at the surface of the layer. A second layer is then deposited containing the complementary developer system. Polymeric layers could be produced as films and then bonded together by a method, such as, solvent bonding, adhesive bonding, or other state-of-the art method known for lamination of paper and plastic films.

The paper substrate can be made weather-resistant by treating one or both sides with a water-repellent substance such as a polymeric coating, wax or wax-like substance, silicone, silicone-based surfactant or fluorinated organic surfactant. The coating can be applied using spray, dip or immersion, roll coating, spin coating or other suitable state-of the art methods used for applying coatings to paper. If both sides are coated, the coating material must be chosen so that leaking material to be detected can diffuse through the coating in order to reach the microcapsules or layer containing the dye precursor. Polymer-based substrates could be used as an alternative to paper.

Chlorofluorocarbons, such as CFC-113 (trichlorotrifluoroethane) and hydrochlorofluorocarbons, such as HCFC-141b (dichlorofluoroethane) can be detected using a microencapsulated leuco dye precursor solution and an external acidic developer typical of early thermally-sensitive printer papers. However, hydrofluorocarbons such as HFC-134a (tetrafluoroethane) and some HCFCs, such as HCFC-22 (chlorodifluoromethane) are incapable of developing color in these systems because the microcapsules are not adequately affected to release the dye precursor from the microcapsule.

Leak detection systems as described above which can be activated by leaking HFCs, such as HFC-134a or HCFCs, such as HCFC-22 should preferably have microcapsule shell material or polymeric layers that demonstrate some degree of solubility in the leaking compound. Acrylonitrile-butadiene-styrene terpolymer is at least partially solubilized by HFCs, such as HFC-134a (tetrafluoroethane), HFC-152a (difluoroethane), HFC-32 (difiruoromethane) and HCFCs, such as R-124 (chlorotetrafluoro-ethane) and HCFC-22 (chlorodifluoromethane). Similarly, HFC-22 affects polyphenylene oxide and polycarbonate.

Acrylic, styrene, ethylene tetrafluoroethylene, polyvinlyidene fluoride, polychlorotetraflurorethylene, vinylidene chloride, vinylidene chloride/vinyl chloride, cellulosic, polysulfone, polypropylene, polyphenylene sulfide, polyphthalamide, polyamideimide, polyphenylene sulfide, and polyester are affected by a number of HFCs and HCFCs, and are examples of materials that can be used for microcapsule shell material or polymeric layers as previously described.

Polyvinylpyrrolidone, copolymers of polyvinlypyrrolidone/vinyl acetate (PVP/VA), PVP/dimethylamino-ethylmethacrylate and vinyl caprolactam/PVP/dimethylamino-ethylmethacrylate are also at least partially soluble in HFCs such as R-134a and can be utilized as microcapsule shell materials or polymeric layers to contain dye precursor and developer systems.

Any polymeric material can be used as the microencapsulant provided it is not dissolved by the contents housed in the microshell and is sufficiently affected by the compound intended to be detected during leak detection. Gel-like materials including natural gums, such as carageenan, guar, agar, locust bean, gum Arabic, karaya, natural gelatin, methyl cellulose, ethyl cellulose, can also be used. Further examples of materials that can be used as microcapsule/film materials are listed in table 3 below.

TABLE 3
Materials suitable for microcapsules

Polyoxymethylene (Acetal)
Acrylonitrile-Methyl Acrylate Copolymer (AMA)
Cellulosic
Ethylene-Chlorotrifluoroethylene Copolymer (ECTFE)
Ethylene-Tetrafluoroethylene Copolymer (ETFE)
Fluorinated Ethylene-Propylene Copolymer
Perfluoroalkoxy Resin (PFA and MFA)
Polychlorotrifluoroethylene (PCTFE)
Polytetrafluoroethylene (PFE)
Polyvinyl Fluoride (PVF)
Polyvinylidene Fluoride (PVDF)
Hexafluoropropylene,
Tetrafluoroethylene,
Ethylene (THE)
Tetrafluoroethylene,
Hexafluoropropylene,
Vinylidene Fluoride Terpolymer (THV)
Ionomer
Polyparaxylylene
Polyethylene Naphthalate
Polyamide
Polyetherimide
Polyaryletherketone
Polyaryletheretherketone
Polyamide-imide
Amorphous Nylon
Nylon 6 and PA6
Nylon 66 and PA6,6
Nylon 66/12 and PA6/12
Nylon 66/69, Nylon 66/69/6I, and PA66/69, PA66/69/6I
Nylon 66/610
Nylon, Polyamide
Polycarbonate (PC)
Polybutylene Terephthalate (PBT)
Polyethylene Naphthalate (PEN)
Gylcol Modified Polycyclohexylenedimethylene Terephthalate (PCTG)
Polycyclohexylenedimethylene Ethylene Terephthalate (PETG)
Polyethylene Terephthalate (PET)
Liquid Crystal Polymer (LCP)
Polyimide
Polyethylene (ULDP, LDP, MDPE, LMDP, HDPE)
Polyolefin Plastomers (POP)
Cyclic Olefin Copolymer (COC)
Ethylene-Vinyl Acetate Copolymer (EVA)
Ethylene-Vinyl Alcohol Copolymer (EVOH)
Polyethylene-Acrylic Acid Copolymer (EAA)
Polypropylene (PP)
Polybutylene
Polyphenylene Sulfide
Polysulfone
polyphthalamide
Polyarlysulfone
Polyethersuflone
Polyester
Polyvinyl Alcohol (PVOH)
Acrylonitrile-Butadiene-Styrene Copolymer (ABS)
Acylonitrile-Styrene-Acrylate Copolymer (ASA)
Polystyrene (PS)
Oriented Polystyrene (OPS)
General Purpose Polystyrene (GPPS)
Impact Resistant Polystyrene (HIPS)
Styrene-Acrylonitile Copolymer (SAN)
Styrene-Butadiene Block Copolymer (SBS)
Styrene-acrylate
Styrene-methacrylate
Polyvinyl Chloride (PVC)
Polyvinylidene Chloride (PVDC)
Polyethylene/Polystyrene Alloy (PE/PS)
Epoxy Resin (EP)
Paraffin wax
Polyurea
Polyurethane
Urea-formaldehyde resin

As with solvent and dye precursors, if the microcapsule or film materials do not provide the necessary compatibility with dye or the necessary solubility with the leaking compound to be detected, the material can be functionalized. A specific chemical group or groups, such as hydrogen, halogen (chlorine, fluorine, bromine, iodine), hydrocarbons of straight or branched chain, unsaturated, cyclic, aromatic (methyl, ethyl, propyl, isopropyl, butyl, isobutyl, phenyl, benzyl, bi-phenyl, -ene, -yne.), oxygen-containing (hydroxyl, ketone, aldehyde, organic acid, ether, or ester), nitrogen-containing (nitro-, nitroso-, amine and amide), sulphur (sulfo- and sulfonyl) can be appended to the original solvent via chemical reaction.

Microcapsule materials for other leak detection purposes, such as detection of flammable hydrocarbons, include alcohols, ketones and other compounds known to those skilled in the art.

Although not every microcapsule or film material, solvent or carrier can be listed here for practical reasons, leak detection media as described in the present invention can be made by at least one acid (leuco dye precursor developer) from Table 1, at least one solvent/carrier from Table 2, at least one microcapsule/film material from Table 3 and, as appropriate, at least one dye precursor (intermediates, leuco form, carbinol form, or diazonium salts from diazotization of primary aromatic amines, couplers, and base or acid as described above in the detailed description.

In most cases, the dye precursor with or without solvent is housed in the microcapsules or film and the developer is external to the microcapsules or film or would be hosted in isolated fashion within the same film or separately in an adjoining film or within another set of microcapsules.

Other methods of encapsulation are described in U.S. Pat. Nos. 4,842,979; 4,482,624 and references cited therein, all of which are incorporated in their entirety by reference. Oil soluble materials have been encapsulated in hydrophilic wall-forming materials, such as, gelatin-type materials, including gum arabic, polyvinyl alcohol, carboxy-methyl-cellulose (see U.S. Pat. Nos. 2,730,456 and 2,800,457 to Green et al); resorcinol-formaldehyde wall formers (see U.S. Pat. No. 3,755,190 to Hart et al); isocyanate wall-formers (see U.S. Pat. No. 3,914,511 to Vassiliades); isocyanate-polyol wall-formers (see U.S. Pat. No. 3,796,669 to Kirintani et al); urea formaldehyde wall-formers, particularly urearesorcinol-formaldehyde in which oleophilicity is enhanced by the addition of resorcinol (see U.S. Pat. Nos. 4,001,140; 4,087,376 and 4,089,802 to Foris et al); melamine-formaldehyde resin and hydroxypropyl cellulose (see U.S. Pat. Nos. 4,025,455 and 4,771,032); and practical examples of the methods of microencapsulation and compounds for use in these methods (see U.S. Pat. Nos. 3,726,804 and 3,796,669). All of the aforementioned references are incorporated herein in their entirety by reference thereto.

To further illustrate embodiments of the invention, a dye precursor, such as, a leuco dye precursor, can be dissolved in a high-boiling aromatic solvent and subjected to a microencapsulation process. The resulting microcapsules can then be applied to a substrate, such as paper. Other substrates, such as plastic films, can also be used.

Filler

A filler, such as talc or other fillers known to those skilled in the art, can optionally be used in the external package to moderate capsule breakage and thus aid in minimizing color development due to handling. Those substances are applied to the microcapsules externally, for example, on the microcapsule shell itself, or on the media substrate, such as paper.

Mode of Operation

Typically, the dye precursor is released from the microcapsule either by diffusion, dissolution, rupture or other processes. Thus, the dye precursor can be released from the microcapsule by absorption, adsorption, or diffusion of the chemical into the microcapsule leading to rupture of the encapsulation by crazing, cracking, or other degradation or dissolution.

The chemical may also dissolve in the dye precursor and thus alter the physical state, such as solid to liquid or lower the solution viscosity to aid release.

Color develops when the dye precursor is released from the microcapsule and comes into contact with a developer that has been externally applied to the microcapsules.

The selection of the components of the leak detection system, i.e., the microcapsule, film material, solvent or carrier for the dye precursor, developing agents, fillers, and other agents, as necessary, is strongly influenced by the compound that is to be detected. For example, the materials selected for leak detection of natural gas may be different than the materials selected to detect 1,1,1,2-tetrafluoroethane. In essence, by selecting the appropriate components that make up the leak detection means described herein, a variety of volatile compounds could be detected.

The microcapsule or film containing the dye precursor must be sufficiently affected by the leaking compound to degrade the integrity of the microcapsule to such an extent that the dye precursor is released from the microcapsule and comes into contact with the developer to form a detectable color. At the same time, the solvent or carrier for the dye precursor, if one is used, must be compatible with the microcapsule or film material, i.e., the solvent must not swell, dissolve, crack, or otherwise degrade the integrity of the microcapsule or film prior to contact with the leaking chemical. In addition, the developing agents or fillers selected should not significantly diminish the effects of the leaking compound on the microcapsule or film containing the dye precursor, nor should they significantly degrade the integrity of the microcapsule or film.

Alternatively, the solvent used to solubilize the dye precursor may be selected to be soluble with the leaking compound or alternatively, insoluble with the leaking compound.

When a leaking chemical, such as, a volatile organic compound, comes into contact with the leak detection media containing the microcapsule, the leaking chemical degrades the integrity of the microcapsule by dissolution, diffusion or rupture to release the dye precursor, such as the leuco dye precursor, from the microcapsule and allow it come into contact with the acidic developer to form a characteristic color.

In the practice of the present invention, a strip or tape of the leak detection media is wrapped around a piping joint or similar area suspected of leaking.

In another embodiment, a tape is placed on a joint that is not yet leaking as a site-specific monitoring device for preventive maintenance.

In still another embodiment, a patch is used in place of tape where suspected or potential leak site has a flat geometry rather than a circular cross-section.

In yet another embodiment, a patch can be mounted on a wall or suspended above equipment as a means of area monitoring.

In another embodiment, the leak detection media would be placed as a leak detection monitor in the vicinity of a system containing a volatile organic compound.

In still another embodiment, liquid and gaseous compounds are classified by contacting the leak detection medium with the compound where it has been previously ascertained that a given compound or family of compounds either is or is not detectable with a given leak detection medium.

Thus, different media used to form the different microcapsule or film materials may optionally be used in combination with different solvent or carriers so that the dye precursor can provide a means for leak detection of virtually any volatile liquid or gas and field classification of virtually any liquid or gaseous compound.

An advantage of this type of leak detection media is that the development of color in the leak detection media of the present invention is cumulative, i.e., as more of the leaking compound contacts the media, the more color development occurs. In this way, even very small leaks can be pinpointed simply by waiting longer for color to develop.

The present invention has been described with particular reference to the preferred embodiments. It should be understood that variations and modifications thereof can be devised by those skilled in the art without departing from the spirit and scope of the present invention. Accordingly, the present invention embraces all such alternatives, modifications and variations that fall within the scope of the appended claims.

1. A method of detecting leakage of a chemical, said method comprising the steps of:
placing a test strip in close proximity of or in direct contact with a suspected leak, said test strip comprising a support material and a color forming composition disposed on said support material, said color forming composition comprising a dye precursor encapsulated in a microcapsule, a developer and, optionally, a filler; and
detecting an alteration of the color on said test strip in response to leakage of said chemical.

2. The method of claim 1, wherein said color alteration on said test strip results from having said microcapsule come into contact with said chemical, thereby releasing said encapsulated dye precursor from said microcapsule, thereby allowing said dye precursor to react with said developer, thereby producing said color alteration of said test strip.

3. The method of claim 1, wherein said support material is a substrate in a form selected from the group consisting of: sheet, tape, patch or film.

4. The method of claim 1, wherein said support material is selected from the group consisting of:
paper, polymer, paper coated on one or both sides with a polymer, metal, metallized paper, metallized polymer, acetate, polyvinyl acetal, polyester, polystyrene, polypropylene, polyamide, polyimide, nitrocellulose, polycarbonate, polyvinylchloride, a composite, metal/paper laminate, Perlon gauze and a combination thereof.

5. The method of claim 1, wherein said support material is a paper coated on one or both sides with a polymer selected from the group consisting of: alpha-olefin, polyethylene and combination thereof.

6. The method of claim 1, wherein said support material is an acetate film selected from the group consisting of: polyvinyl acetate and cellulose acetate.

7. The method of claim 3, wherein said support material is a composite comprising a polyethylene coated polyester, polypropylene or polystyrene.

8. The method of claim 1, wherein said encapsulated dye precursor is selected from the group consisting of: leuco dye, carbinol based dye, diazonium salt capable of coupling with a coupling agent and a combination thereof.

9. The method of claim 8, wherein said leuco dye is a leuco base of a triarylmethane dye.

10. The method of claim 9, wherein said leuco base of a triarylmethane dye is selected from the group consisting of: crystal violet, Cl Basic Violet 1, Cl Basic Violet 2, Cl Basic Blue, Cl Victoria Blue, crystal violet lactone, N-benzoyl leuco-methylene blue and a combination thereof.

11. The method of claim 8, wherein said leuco dye is selected from the group consisting of: phthalide leuco dyes, bisindophtalides, carbazolyl methanes, fluorans and a combination thereof.

12. The method of claim 8, wherein said carbinol based dye is selected from the group consisting of: malachite green, Cl Acid Blue 9, Cl Food Blue 2 and a combination thereof.

13. The method of claim 8, wherein said diazonium salt is the diazotization product of a primary aromatic amine.

14. The method of claim 13, wherein said primary aromatic amine is selected from the group consisting of: 5-amino-1,2,4-thiadiazole, 2-amino-6-nitrobenzothiazole, 2-amino-3,5-dinitrothiophene, 1-amino-2-naphthol-4-sulfonic acid, 2-amino-4-sulfonnic acid, 1-naphthalene-suflamic acid, 4-amino-3-methoxydiphenylamine, 4-amino-2-methoxydiphenyl-amine, 4′-amino-2-methoxydiphenylamine, 4′-amino-4-methoxydiphenyl-amine, 4-amino-3-ethoxydiphenylamine, 4-amino-3-hexyloxydiphenyl-amine, 4-amino-3-beta-hydroxyethoxy-diphenylamine, 4′-amino-2-methoxy-5-methyidiphenyl-amine, 4-amino-3-methoxy-6-methyl-diphenylamine, 4′-amino-4-n-butoxydiphenylamine, 4′-amino-3′,4-dimethoxydiphenylamine, 4-amino-diphenylamine, 4-amino-3-methyl-diphenylamine, 4-amino-3-ethyl-diphenylamine, 4′-amino-3-methyl-diphenylamine, 4′-amino-4-methyl-diphenylamine, 4′-amino-3,3′-dimethyidiphenylamine, 3′-chloro-4-amino-diphenylamine, 4-amino-diphenylamine-2-sulfonic acid, 4-aminodiphenyl-amine-2-carboxylic acid, 4-aminodiphenylamine-2′-carboxylic acid and 4′-bromo-4-aminodiphenyl-amine and a mixture thereof.

15. The method of claim 13, wherein said diazonium salt has a counter anion selected from the group consisting of: halide, sulfate, hydrogen sulfate, phosphate, hydrogen phosphate, dihydrogen phosphate, hexafluorophosphate, tetrafluoroborate, sulfonate selected from the group consisting of: methane sulfonate, trifluoromethane sulfonate, toluene sulfonate, naphthalene sulfonate and mesitylene sulfonate, and any combination thereof.

16. The method of claim 13, wherein said diazonium salt is selected from the group consisting of: diphenylamine-4-diazonium sulfate, 2-4-(N-(naphthyl-2-methyl)-N-propylamino)-benzenediazonium sulfate, chloro-diphenyl-4-diazonium sulfate, 4-(3-phenylpropylamino)-benzenediazonium sulfate, 4-(N-ethyl-N-(benzyl)-amino)-benzenediazonium sulfate, 4-(N,N-dimethylamino)-benzenediazoniumtetrafluoroborate, 4-(N-(3-phenyl-mercapto-propyl)-N-ethyl-amino)-2-chlorobenzenediazonium sulfate, 4-(4-methylphenoxy)-benzenediazonium sulfate, 4-(phenylmercapto)-benzenediazonium sulfate, 4-phenoxy-benzenediazonium sulfate, 4-(benzoylamino)-benzenediazonium hexafluorophosphate, methylcarbazole-3-diazonium sulfate, 3-methyl-diphenyleneoxide-2-diazonium sulfate, 3-methyidiphenylamine-4-diazonium sulfate, 2,3′,5-trimethoxydiphenyl-4-diazonium sulfate, 2,4′,5-triethoxydiphenyl-4-diazonium sulfate, 4-(3-(3-methoxyphenyl)-propylamino)-benzenediazonium sulfate, 4-(N-ethyl-N-(4-methoxybenzyl)-amino)-benzenediazonium sulfate, 4-(N-(naphthyl-(2)-methyl)-N-n-propylamino)methoxybenzenediazonium sulfate, 4-(N-(3-phenoxypropyl)-N-methylamino)-2,5-dimethoxybenzenediazonium tetrafluoroborate, 4-(N-(3-phenylmercaptopropyl)-N-ethylamino)-2-chloro-5-methoxybenzene-diazonium sulfate, 4-(4-(3-methylphenoxy)-phenoxy)-2,5-dimethoxy-benzenediazonium sulfate, 4-(4-methoxy-phenylmercapto)-2,5-diethoxybenzenediazonium sulfate, 2,5-diethoxy-4-phenoxybenzene-diazonium sulfate, 4-(3,5-dimethoxybenzoylamino)-2,5-diethoxybenzene-diazonium hexafluorophosphate, methoxycarbazole-3-diazonium sulfate, 3-methoxy-diphenyleneoxide-2-diazonium sulfate, methoxydiphenyl-amine-4-diazonium sulfate and a combination thereof.

17. The method of claim 13, wherein said diazonium salt is selected from the group consisting of compounds represented by the formula: 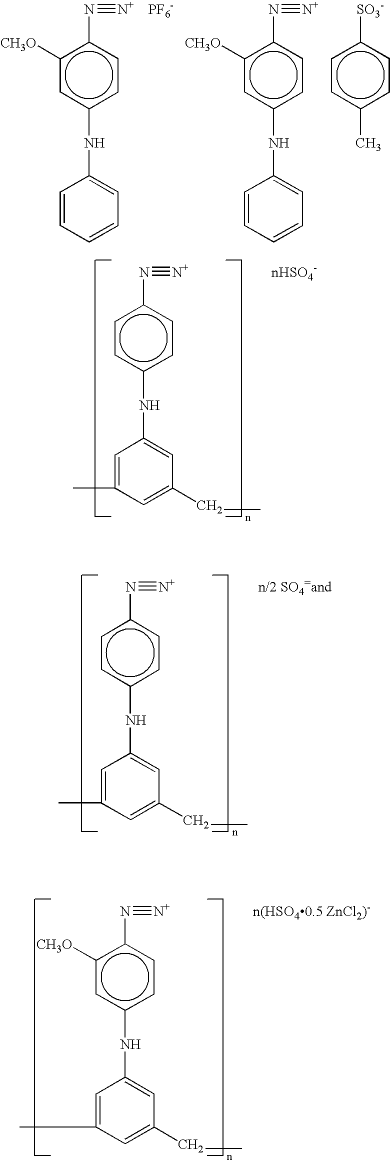
wherein n is from 1 to 11 and a combination thereof.

18. The method of claim 8, wherein said coupling agent is selected from the group consisting of: 2-hydroxy-3-napthoic acid anilide, aromatic amine, phenol, naphthols, pyrrole, pyridene, pyrimidene, indole, active methylene compound, acetoacetanilide, 3-methyl-1-phenyl-5-pyrazolone, 2,4-dihyroxyquinoline, N,N-dimethylaniline, 3-hydroxy-2-naphthanilide, naphthylamine, 8-amino-1-naphthol-3,6-disulfonic acid, 7-amino-1-naphthol-3-sulfonic acid, (benzolyacetic acid-2′-[2-(2-hydroxy-3-naphthoylamino)phenylthio]anilide, 1,2-bis (benzylacetamido)benzene, 4-toluenesulfonyloxy)anilide and a combination thereof.

19. The method of claim 8, wherein said coupling is carried out in the presence of a basic component selected from the group consisting of: ammonium salts, amine compounds, amides, ureas, thioureas, thiazoles, pyrroles, pyrimidines, piperazines, guanidines, indoles, imidazoles, imidazolines, triazoles, morpholines, piperidines, amidines, formamidines, pyridines and a combination thereof.

20. The method of claim 19, wherein said a basic component is selected from the group consisting of: ammonium acetate, tribenzylamine, tricyclohexylamine, octadecylbenzylamine, stearylamine, allylurea, thiourea, methylthiourea, allylthiourea, ethylenethiourea, 2-benzyl-imidazole, 4-phenylimidazole, 2-phenyl-4-methylimidazole, 2-undecyl-imidazoline, 2,4,5-trifuryl-2-imidazoline, 1,2-diphenyl-4,4-dimethyl-2-imidazoline, 2-phenyl-2-imidazoline, 1,2,3-triphenylguanidine, 1,2-ditolylguanidine, 1,2-dicyclohexylguanidine, 1,2,3-tricyclohexylguanidine, guanidine trichloroacetate, N,N′-dibenzylpiperazine, 4,4′-dithiomorpholine, morpholinium trichloroacetate, 2-aminobenzothiazole, 2-benzoyl-hydrazinobenzothiazole and a combination thereof.

21. The method of claim 1, wherein said developer is selected from the group consisting of: an acidic developer for leuco dye precursors and a coupler for diazonium salt precursor.

22. The method of claim 21, wherein said acidic developer is selected from the group consisting of: propionic acid, butyric acid, valeric acid, caproic acid, caprylic acid, capric acid, lauric acid, myristic acid, palmitic acid, stearic acid, oleic acid, cis-9-octadecenoic acid, cis,cis-9,12-““linoleic acid, cis,cis,cis-9,12,15 ”” linolenic acid, cyclohexanoic acid, phenylacetic acid, benzoic acid, o-toluic acid, m-toluic acid, p-toluic acid, o-chlorobenzoic acid, m-chlorobenzoic acid, p-chlorobenzoic acid, o-bromobenzoic acid, m-bromobenzoic acid, p-bromobenzoic acid, o-nitrobenzoic acid, m-nitrobenzoic acid, p-nitrobenzoic acid, phthalic acid, isophthalic acid, terephthalic acid, salicylic acid, p-hydroxybenzoic acid, m-aminobenzoic acid, p-aminobenzoic acid and a combination thereof.

23. The method of claim 1, wherein said encapsulated precursor dye is released from encapsulation by at least one of the following:
absorption, adsorption, diffusion of said chemical into said microcapsule and said encapsulated dye, dissolution of said microcapsule in said chemical, physical degradation of said microcapsule, dissolution of encapsulated dye in said chemical or rupture of said encapsulation and any combination thereof.

24. The method of claim 1, wherein said microcapsule further comprises a solvent.

25. The method of claim 24, wherein said solvent is selected from the group consisting of: alcohols, ketones, aldehydes, oils, amides, glycols, glycol ethers, esters, phthalates, adipates, branched-acid polyol esters, mixed-acid polyol esters, polyalkylene glycols, alkyl benzenes, benzylated ethylbenzene, phosphoric esters, phthalic esters, carboxylic acid esters, fatty acid amides, alkylated biphenyls, alkylated terphenyls, chlorinated paraffins, alkylated naphthalenes, diarylethanes and a combination thereof.

26. The method of claim 24, wherein said solvent is selected from the group consisting of: benzyl alcohol, glycerol, ethylene glycol, propylene glycol, phenol, o-, m-, or p-cresol, o-, m- or p-chlorophenol, o-, m- or p-nitrophenol, catechol, cinnamyl alcohol, phenyl ethyl alcohol, 1,3-propane diol, pentaerythritol, benzaldehyde, m-mitrobenzaldehyde, o-tolualdehyde, acetophenone, benzophenone, paraffin, silicone, polyvinylether, polyol ester, polyalkylene glycol, mineral oil, alkybenzenes, perfluoropolyether, chlorotrifluoroethylene, hydrofluoropolyether, butanamide, n-methylpropanamide, dipropylene glycol, diethylene glycol, butyl diglycol, butyl triglycol, ethyl diglycol, hexyl diglycol, propyl glycol, diethylene glycol monobutyl ether, ethylene glycol monobutyl ether, ethylene glycol monoethyl ether, diethylene glycol monomethyl ether, tripropylene glycol n-butyl ether, hydroquinone monobutyl ether, diethylene glycol monoethyl ether, triethylene glycol monoethyl ether, diethylene glycol monohexyl ether, ethylene glycol monopropyl ether, ethylene glycol phenyl ether, dibutyl phthalate, diethyl phthalate, diisobutyl phthalate, diisononyl phthalate, diisodecyl phthalate, dioctyl phthalate, dilauryl phthalate, dioctyl adipate, benzyl butyl phthalate, isopropylbiphenyl, diisopropyinaphthalene, n-butyl propionate, tert-butyl hdyroquinone, tricresyl phosphate, trioctyl phosphate, octyldiphenyl phosphate, tricyclohexyl phosphate, dibutyl phthalate, dioctyl phthalate, dilauryl phthalate, dicyclohexyl phthalate, butyl oleate, diethylene glycol dibenzoate, dioctyl sebacate, dibutyl sebacate, dioctyl adipate, trioctyl trimellitate, acetyltriethyl citrate, octyl maleate, dibutyl maleate, isopropylbiphenyl, isoamylbiphenyl, chlorinated paraffins, 1,1′-ditolytethane, 2,4-di-t-aminophenol and N,N-dibutyl-2-butoxy-5-t-octylaniline and mixtures thereof.

27. The method of claim 1, wherein said encapsulated precursor dye is encapsulated by a method selected from the group consisting of:
solvent evaporation, simple coacervation, complex coacervation, polymer-polymer incompatibility, centrifugal force, submerged nozzle process, spray drying, fluidized-bed coating, desolvation, extractive drying, interfacial polymerization, in situ polymerization, biliquid column, electrostatic encapsulation, ethylene polymerization, very low temperature casting, supercritical fluid extraction and a combination thereof.

28. The method of claim 1, wherein said encapsulated precursor dye has a microcapsule shell material selected from the group consisting of:
acrylonitrile-butadiene-styrene terpolymer, polyphenylene oxide, polycarbonate, acrylic polymer, styrene, ethylene tetrafluoroethylene, polyvinlyidene fluoride, polychlorotetraflurorethylene, vinylidene chloride, vinylidene chloride/vinyl chloride, cellulosic, polysulfone, polypropylene, polyphenylene sulfide, polyphthalamide, polyamideimide, polyphenylene sulfide, polyester, polyvinylpyrrolidone, polyvinlypyrrolidone/vinyl acetate (PVP/VA) copolymers, PVP/dimethylamino-ethylmethacrylate copolymers, vinyl caprolactam/PVP/dimethylamino-ethylmethacrylate polymers, guar, carageenan, agar, locust bean, gum Arabic, karaya, natural gelatin, methyl cellulose, ethyl cellulose, polyoxymethylene, acrylonitrile-methyl acrylate copolymer, cellulosic material, ethylene-chlorotrifluoroethylene copolymer, ethylene-tetrafluoroethylene copolymer, fluorinated ethylene-propylene copolymer, perfluoroalkoxy resin, polychlorotrifluoroethylene, polytetrafluoroethylene, polyvinyl fluoride, polyvinylidene fluoride, , vinylidene fluoride terpolymer, ionomer, polyparaxylylene, polyethylene naphthalate polyamide, polyetherimide, polyaryletherketone, polyaryletherketone, polyamide-imide, amorphous Nylon, Nylon 6 and PA6, Nylon 66 and PA6,6, Nylon 66/12 and PA6/12, Nylon 66/69, Nylon 66/69/61, and PA66/69, PA66/69/61 Nylon 66/610, Nylon, polyamide, polycarbonate, polybutylene terephthalate, polyethylene naphthalate, gylcol modified polycyclohexylenedimethylene terephthalate, polycyclohexylenedimethylene ethylene terephthalate, polyethylene terephthalate, liquid crystal polymer, polyimide, polyethylene, polyolefin cyclic olefin copolymer, ethylene-vinyl acetate copolymer, ethylene-vinyl alcohol copolymer, polyethylene-acrylic acid copolymer, polypropylene, polybutylene, polyphenylene sulfide, polysulfone, polyphthalamide, polyarlysulfone, polyethersuflone, polyester, polyvinyl alcohol, acrylonitrile-butadiene-styrene copolymer, acylonitrile-styrene-acrylate copolymer, polystyrene, oriented polystyrene, general purpose polystyrene, impact resistant polystyrene, styrene-acrylonitile copolymer, styrene-butadiene block copolymer, styrene-acrylate copolymer, styrene-methacrylate copolymer, polyvinyl chloride, polyvinylidene chloride, polyethylene/polystyrene alloy, epoxy resin, paraffin wax, polyurea, polyurethane, urea-formaldehyde resin and a combination thereof.
